(19) United States
(12) Patent Application Publication
(10) Pub. No.: US 2007/0036277 A1
(43) Pub. Date: Feb. 15, 2007

(54) Craft menu system using caller ID functionality for installation and testing

(76) Inventors: Douglas A. Atkinson, Ashburn, VA (US); John Taliaferro Burch, McLean, VA (US)

Correspondence Address: John P. Moran;Holland & Knight LLP, Suite 100, 2099 Pennsylvania Ave., Washington, DC, 20006, US

(21) Appl. No.: 11/367,423

(22) Filed: Mar. 6, 2006

Related U.S. Application Data
(63) Continuation of application No. 10/662,716, filed on Sep. 15, 2003, now Pat. No. 7,123,692.

(51) Int. Cl. H04M 1/24

(52) U.S. Cl. 379/21; 379/142.01

(57) ABSTRACT

A craft menu system, in a presently preferred embodiment, includes a network terminal like an ONT, having a processor and memory and multiple data ports, configurably coupled to a DTMF telephony (e.g., BUTT) test set for installation and testing. The installation, registration and testing information needed by a technician is provided by the ONT to the BUTT set display using convenient Caller ID signaling, and technician data entry is accomplished via the DTMF-enabled keys on the BUTT set. This system allows a single technician, equipped with current standard tools like a BUTT set and without the need for additional tools like a PC or PDA, to install and test a craft menu enabled ONT in a timely and efficient manner.

### FIELD OF THE INVENTION

The invention in general relates to the field of communications, and more particularly to premises broadband communication systems.

### BACKGROUND

One of the key challenges in the communications industry today is how to provide a cost effective, broadband solution for getting multiple services, such as telephony, video, and high speed data, to users in such diverse premises as homes and business buildings. The existing telephone service, sometimes known as plain old telephone service (POTS), may suffice for some telephony and data requirements, but is bandwidth constrained and inadequate for more demanding services like video provisioning. Cable television (CATV) systems do provide a broadband solution for delivering digital and video data, but the reliance on coaxial cable for the final distribution to homes and other premises remains a bandwidth limited solution. Thus, because of the superior bandwidth of fiber optic solutions, a variety of systems have been proposed to provide fiber to the home/business (FTTH/B) as the best overall solution for broadband services.

The leading FTTH/B solutions rely on passive optical networks (PONs), in which the optical network is terminated at the premises in some form of optical network terminator (ONTs). However, one problem present in, today's solutions for coupling the optical networks, via the ONTs, to local premises networks, is the expense and complication of providing trained technicians with the necessary set-up equipment for the given installation. In a typical telephony installation, technicians carry a general technician toolkit to install cables (phone lines) and a simple BUTT set to test these phone lines. More is required in a FTTH/B installation, though, so more specialized tools and training are required to roll out these new services. These tools have included PDAs (personal digital assistants) or even laptop computers, for handling specialized functions like system registration and a suite of test functionality. These existing solutions are both more costly and time consuming.

Thus, there remains a need for a simpler, more cost effective and efficient solution for installing and testing broadband (e.g., optical) and local premises networks. Just such a solution to these and other problems noted above, is made possible by my invention.

### SUMMARY

An illustrative summary of the invention, with particular reference to the detailed embodiment described below, includes a network terminal such as an ONT, having a processor and memory and multiple data ports. The ONT is configured for coupling to a DTMF telephony (e.g., BUTT) test set for installation and testing. The registration and testing information that is needed by the technician to complete an installation or test is provided by the ONT to the BUTT set display using convenient, signaling like a Caller ID format, and data entry from a technician is accomplished via the DTMF-enabled keys on the BUTT set. An appropriately configured menu system stored in the ONT allows a single installation technician using this system, equipped with current standard tools like a BUTT set but without the need for additional tools like a PC or PDA, to install or test an ONT in a timely and efficient manner.

### THE FIGURES

My invention may be more readily appreciated from the following detailed description, when read in conjunction with the accompanying drawings, in which:

FIG. 1 is a general block diagram of a system illustrating a test unit and network terminal for use in installation and testing within a premises according to a first embodiment of the invention;

FIG. 2 is a flow chart illustrating installation and testing methods for use in the system of the first embodiment.

### DETAILED DESCRIPTION OF AN EMBODIMENT OF THE INVENTION

A presently preferred embodiment according to our invention includes a network terminal configured to provide installation and testing information by way of appropriately formatted display characters (e.g., Caller-ID data) to a simple test unit like a telephony BUTT set. When connected to the BUTT set, the user/technician can be prompted to enter required and/or optional information via the input (e.g., a DTMF key pad on the BUTT set), and by a series of pre-defined steps expeditiously and cost-effectively complete the desired installation and test steps. Since the intelligence is in the ONT, this preferred solution can be implemented using standard technician equipment. This enables a cost effective and rapid deployment of FTTH/B solutions, while minimizing the risk of configuration mistakes during installation and testing. A particular example is given below dealing with entering registration codes for newly installed ONTs, but this system is also designed for other test and set-up uses, such as for trouble-shooting of registered network terminals or re-registering repaired or replaced ONTs.

A preferred network terminal is an ONT, having an interface for installation and maintenance utilizing a standard Caller-ID process (e.g., based on (GR-30-CORE) FSK) for signaling to the test unit/BUTT set, from which a menu system may be displayed via a Caller-ID display. The return signaling is readily accomplished using a standard key pad, the DTMF signals being formatted in a Caller ID-compatible format,(i.e., GR-30 compliant messaging from a CPE (the BUTT set) to an SPCS (the ONT)); the signaling is then received, converted and processed by the ONT. With the implementation of an easily changeable menu system, the Service Provider can define a menu system that utilizes the numeric input from the BUTT set and Caller ID to guide a technician through processes such as registration and testing. The technician will be presented with test prompts and can select options and enter values from the keys on the BUTT set.

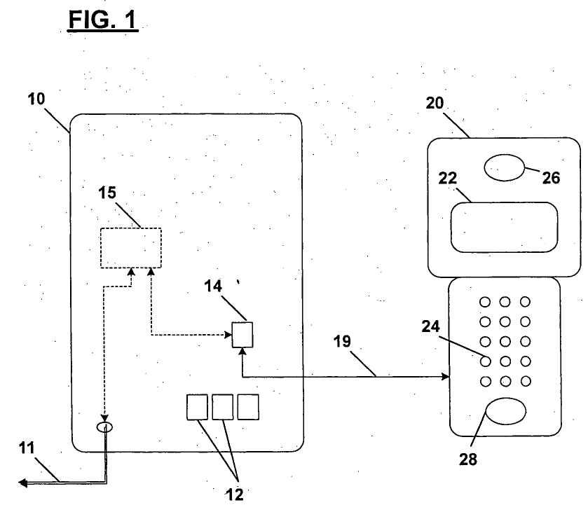

FIG. 1 illustrates a system according to the presently preferred embodiment. BUTT set 20 is coupled to ONT 10 via RJ-11 port 14 and cable 19. ONT 10 has additional ports 12 for its other functionality, and is coupled to an OLT (Optical Line Termination, not shown) of the external network via cable 11. A processor and memory 15 contain appropriate system programming, including the code and settings for use in registration and testing (e.g., testing of in house wiring, system testing, etc.) of the ONT and premises communications system. BUTT set 20 includes a caller ID display 22, a key pad 24 for entry of alphanumerics by a user, and a speaker 26 and microphone 28 and other typical and/or optional BUTT set circuitry.

The processor and memory 15 can be any convenient form, preferably implemented as part of the components used for other functionality of the ONT. The actual software or firmware may vary depending on the specific design needs to the given networks and terminators involved, and may be loaded at the factory or later, at the carrier's premises in batch or even in the field, locally or (for units already coupled to the carrier's network) remotely. Also part of the ONT are converters for converting the data to and from the ONT processor between its normal processing format on the one hand, and the inbound Caller ID-compatible (i.e., SPCS to CPE for the ONT to BUTT set link) and outbound signaling (i.e., CPE to SPCS for the BUTT set to ONT link, or DTMF) formats on the other hand. One skilled in the art will readily appreciate that there are many alternatives available, with particular selections being dictated by the design choices of the manufacturer or service provider.

In the preferred embodiment, the process of registering the ONT requires the input of a registration code via the BUTT set, that is sent on to the OLT and management system. At initial power up, the ONT could be configured to boot to a registration menu. Once a registration code is successfully entered and a configuration received from the OLT, the registration portion of the menu system is disabled. In order to re-enable this menu, the system may be defaulted.

The system utilizes the Caller ID function in the Off Hook state to send messages to the BUTT set. These messages can be defined to ask for serial numbers, work order numbers or to execute specific tests. The system reports back entered DTMF (dual-tone multi-frequency) digits for confirmation to insure the entry is correct.

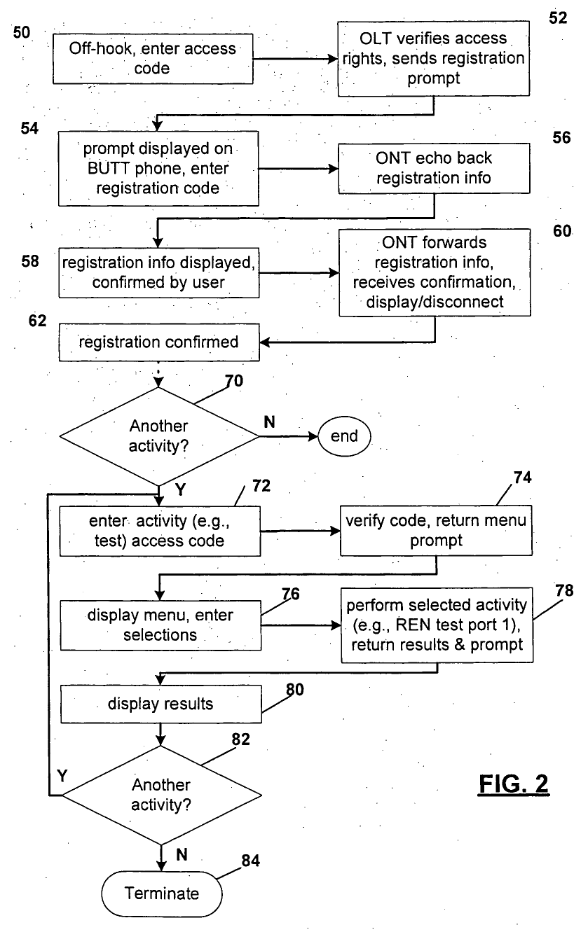

For security purposes, the BUTT set should be jacked into highest number RJ-11 port on the ONT. Once jacked in, a security access code is entered (see FIG. 2, step 50). The code can be designed such that it cannot be interpreted as an input phone number. An example would be “#*#*#*555”+a carrier defined number stored in a boot profile that is factory loaded.

Once entered correctly, the system would then reply with a message, such as: “Enter Registration Code—Followed by # sign” (step 52). If the BUTT set is still attached when registration completes, a message “Registration Complete, Menu, Disabled” will be displayed.

The user would enter the registration code on the BUTT set keypad and appropriate termination like the # sign. This number could be echoed back via Caller ID for confirmation. This insures that the registration code is authenticated before the ONT tries to establish communications and reduces the chance of duplication or keystroke error. (Steps 54-58). The ONT then establishes communications with the carrier system and forwards the registration information for processing, and a signal sent back to the BUTT set either confirming successful registration or indicating that registration failed. (Steps 60, 62).

In support of maintenance and troubleshooting, a different menu system based on the same Call-ID menu system can be accessed. This can be a continuation of the same session as the initial registration, or a new session. If a new session, the technician may simply begin by plugging the BUTT set into the highest numbered POTS port on the ONT. Once plugged in, the technician enters a predefined test access code. Once accepted, the menu will be displayed on the Caller ID-device. Through the menu system, the technician will be able to run ONT diagnostics and have the results displayed to the BUTT set Caller-ID screen. (Steps 70-80)

From here, the system could display an “Installation Test” menu for initial turn-up testing. This menu may direct the technician to select MTL (matrix template library ??) tests, Ethernet test of internal systems test functions and provide PASS/FAIL information to the technician. This information can also be stored on the ONT for later retrieval by a carrier management system.

Example Test Series. The following provides an illustrative example of an installation test series that can be performed in connection with the first embodiment:
Test Menu Display: 1) POTS 2) ETHERNET 3) INTERNAL
User Entry: 1#
Menu Display: 1) REN 2) DC CURRENT 3) . . .
UserEntry: 1#
Menu Display: Enter PORT 1-4
User Entry: 1#
Menu Display: TEST PASS 4 REN LOAD
Menu Display: 1) MAIN MENU 2) UP LEVEL 3) EXIT

Illustrative Features. In a currently preferred system, a Caller-ID interface is used to emulate a text terminal that supports ASCII characters 0-255. This system uses the DTMF tones: of a telephone handset as inputs 0-9, #and *. This basic system conveniently utilizes a process similar to a UNIX TTY to handle the basic input and output for the two devices. This system has been preferably implemented with the following illustrative feature set:

Menu System Enable/Disable: This is settable in a profile, as a carrier may not wish to use the function. It typically works from only one RJ-11, and the port used for the interface is preferably always the highest number POTS port. In the V-142 this is port 4, in the V-182, this is port 8.

Interoperability: The system is preferably designed to work with BUTT sets like the Harris TS25D BUTT set, but can work with any test set that utilizes a GR-30-CORE Caller ID set and DTMF tone generation.

Wake-up Code: This is preferably defined in the factory-loaded system profile. This code is entered by the technician with the BUTT set via DTMF tones. The code should not be one that could be interpreted as a dialed number, so should start with a *,# (**##**##) combination followed by a numeric sequence defined below as the Access Code. The length should be short, e.g., no more then 10 DTMF sequence symbols.

Access Code: The numeric portion of the overall access code entered by the technician through DTMF tones. The length should be short, e.g., no more then 10 DTMF sequence symbols.

Registration Code: The Registration code is stored as the PLOAM (physical layer operation, administration, and maintenance) Password and passed to the OLT upon request.

Illustrative States: The states described below preferably utilize the processes and requirements listed in GR-30-CORE for the transmission of data in the Off-Hook state. The menu system does not need to utilize the defined On-hook state. In the Off-hook state, the equipment sends a CAS (CPE (customer premises equipment) alerting signaling) signal to the Caller-ID set (CPE) before the transmission of any data and will wait for the ‘ACK’ (acknowledgement signal) to be returned by the Caller-ID set. The timing requirements between the CAS and ACK are currently defined in Section 2.2.3.1 of the GR-30-CORE specification.

All transmitted text messages preferably adhere to the message format defined in Section 2.3 of GR-30-CORE. For simplicity, all message can use GDMF (generic data message format) for transmission as defined in Section 2.3.3. The following are illustrative of the states used in a presently preferred embodiment:

State 0: On Hook

State 1: Port 4/8 off Hook. Read DTMF, if * or # check next looking for Wake-up code. If not * or #, pass thru for dialing. If second tone is a number pass thru for dialing. If second tone equals second tone in wake-up code, continue waiting and checking. If wake-up code valid, enter wake-up State 2. Otherwise, invalid phone number entered, process as phone number error.

State 2: Menu Wake-Up. Send Via FSK to Caller-ID set “Enter Access Code, select # to Either”. If no DTMF detected in five seconds, exit wake-up state and return to normal off-hook wait State 1. If DTMF detected, echo to Caller ID and validate after # detected against ‘Access. Code’. If no # detected in five seconds, return to State 1. If Access Code OK, go to State 3. If Access Code invalid, go to start of State 2 and increment failure counter. If Failed 3 times, go to State 1.

State 3: Enter Menu System—Get Registration ID. If Registration ID exists, go to State 4. Send to Caller ID: “Enter Registration ID, Select # to Enter”. If no DTMF detected in five seconds, return to State 1. If DTME detected, echo back to Caller ID until t detected (before eleventh tone). If no # by eleventh tone, send error message and return to State 3: “Error-Registration ID, max 10 digits”. If a # is detected in eleven tones, ask for verification of Registration ID. Send Message to Caller ID “Reg ID is ?: Enter 1 to accept, 0 to re-enter, or 5 to exit”. If 1 Received, send Message “Registration ID Accepted”. If 0 received, go to start of State 3. If 5 received go to State 1. If no tone received in five seconds, go to State 1. If any other tone detected, error message: “Enter 1 to accept, 0 to re-enter, or 5 to exit”.

State 4: Maintenance Menu. The Maintenance Menu should preferably be defined in an interpreted text file like a C-shell script. This will allow the carrier to add new commands over time as functionality changes. A small example follows for purposes of illustration:

SEND “Welcome to V-142”
SEND “Maintenance Menu: 1-Sys Diag 2-MLT 3-Exit
If 1 then SYSDIAG
If 2 then MLT
If 3 then EXIT
#SYSDIAG
SEND “1:Memory Test 2:?
#MLT
SEND “1: 2: REN 3: 4: 0: Up Level
If 1 then XXXX
If 2 then REN
If 3 then YYYY
If 4 then ZZZZ
If 0 then SYSDIAG
Else MLT
# REN
SEND “Select Line (1-4) 0: Up Level:”
If 1 then exec RENtest 1
If 2 then exec RENtest 2
If 3 then exec RENtest 3
If 4 then exec RENtest 4
If 0 then MLT
Else REN
If Return(0) SEND “Test Passed with REN Value XX”
Else SEND “Test Failed”
Go to REN
#EXIT
SEND “Exiting Menu System”
Return to State #1

The script may utilize command line codes to execute the required test with all parameters provided by through the script interface. In the example, RENtest is a CLI (command line interface) command that requires a port number input. The returned data from the executed test will be sent to the Caller ID device. Bad Scripts should exit to State 1, with an error message “Error in Script at Line XX”.

The system allows the technician to turn off the ‘Write’ functionality once turn-up testing is completed. The serial number or other required fields can only be changed via a remotely established terminal session. Non-intrusive test functions will still be available through this Craft method.

Many ONTs have RS-232 interfaces for connection of a data terminal. This port can provide access to a larger number of functions in the ONT operating system. The port is located in the carrier accessible area and can be disabled remotely through the EMS. With the flexibility of the system above, we see no reason for the technician to utilize this port.

Thus, in a first embodiment of my invention there is provided a system for configuring or testing optical network terminators (ONT) and premises communication systems, the embodiment including (a) an ONT, having programming including a menu-driven installation/test program capable of generating user prompts encoded for display via a caller ID display and responsive to user inputs; (b) a butt set coupled, to the ONT, having a display operable to display alphanumeric information received from said program via caller ID formatted signaling, and including an input keypad for the user to input responses to the program prompts; (c) wherein the installation program generates menus for display on the BUTT phone, and is responsive to DTMF replies entered via the keypad in response to the information displayed on the display. Thus, the ONT programming controls system tests and services for the ONT in response to BUTT set inputs. ONT configuration information may additionally be provided to an operator of the BUTT set via the display.

While the above describes one embodiment of the invention used in connection with ONT installation and testing, those skilled in the art will appreciate that there are a number of alternatives, based on system design choices and the like, that still fall within the spirit of my invention. Form example, different registration and other installation codes, authentication processes, and even additional menu-driven processes are possible, and are readily implemented via an appropriate change in ONT programming. Further, while the above has been described in connection with, ONTs, its application can extend to other network terminating devices at a premises boundary, and the user prompt and input can be achieved by means similar, but not identical to, a caller-ID enabled (via LED, LCD or other display) BUTT set.

I claim:

1-18. (canceled)

19. A broadband network termination apparatus for coupling a premises network to a broadband network and providing broadband data services to the premises network, comprising:
a first data port adapted to receive a cable operably coupled to the broadband network, and a further voice services data port adapted to receive a cable operably coupled to the premises network;
a processor operably programmed (1) to provide at least one of installation and test menus to a DTMF telephony test set using inbound signaling having a certain format, and (2) to receive user response input through the test set in which outbound DTMF signals are formatted in a compatible format with respect to the certain format, wherein the menus are defined in corresponding text files, enabling accommodation of future changes.

20. The apparatus of claim 19, wherein the text files are defined by a service provider.

21. The apparatus of claim 19, wherein the text files comprise C-shell scripts.

22. The apparatus of claim 21, wherein the scripts utilize command line codes.

23. The apparatus of claim 19, wherein the processor is programmed by a manufacturer.

24. The apparatus of claim 19, wherein the processor is programmed by a service provider; and the menus are enabled and disabled by the service provider.

25. The apparatus of claim 24, wherein the processor is programmed remotely.

26. The apparatus of claim 19, further comprising a registration menu, the registration menu displayed during the network termination apparatus's initial power up.

27. The apparatus of claim 26, wherein the registration menu is disabled after completing registration.

28. The apparatus of claim 27, wherein the registration menu is re-enabled by defaulting the network termination apparatus.

29. The apparatus of claim 19, wherein the certain format and the compatible format are Caller-ID formats.

30. The apparatus of claim 19, wherein the processor operates in a plurality of states, the states including an On Hook state, an Off Hook state, a Menu Wake Up state, an Enter Menu System state, and a Maintenance Menu state.

31. The apparatus of claim 30, wherein the processor operating in the Off Hook state includes the processor communicating an alert signal to, and receiving an acknowledgement signal from, the test set.

32. The apparatus of claim 30, wherein the processor operating in the Menu Wake Up state includes the processor obtaining and determining validity of an access code.

33. The apparatus of claim 30, wherein the processor operating in the Enter Menu System state includes the processor obtaining and determining validity of a registration ID.

34. The apparatus of claim 30, wherein the processor operating in the Maintenance Menu state includes the processor implementing the menus defined in the corresponding text files.

35. A method for providing broadband data services to a premises network, comprising the steps of:
a. operably coupling a network termination device and a DTMF telephony test set device;
b. providing an access code to the network termination device via the test set device, and sending a response from the network termination device to a user of the test set device via a display operable for displaying data having a certain format on the test set device, wherein the network termination device operates in a plurality of states, the states including an On Hook state, an Off Hook state, a Menu Wake Up state, an Enter Menu System state, and a Maintenance Menu state.

36. The method of claim 35, wherein operating in the Off Hook state includes communicating an alert signal to, and receiving an acknowledgement signal from, the test set device.

37. The method of claim 35, wherein operating in the Menu Wake Up state includes determining validity of the access code.

38. The method of claim 35, wherein operating in the Enter Menu System state includes obtaining and determining validity of a registration ID.

39. The method of claim 35, wherein operating in the Maintenance Menu state includes communicating menu prompts for display via the test set device.

40. The method of claim 39, wherein the menu prompts are defined by corresponding text files, enabling accommodation of future changes.

41. The method of claim 40, wherein the text files are defined by a service provider.

42. The method of claim 40, wherein the text files are C-shell scripts.

43. The method of claim 42, wherein the scripts utilize command line codes.

44. The method of claim 39, wherein the communicating of menu prompts are enabled and disabled by a service provider.

45. The method of claim 35, further comprising the step of:
c. storing information communicated between the network termination device and the test set device on the network termination device.

46. The method of claim 35, wherein the certain format is a Caller-ID format.
